(19) United States
(12) Patent Application Publication
(10) Pub. No.: US 2026/0307418 A1
(43) Pub. Date: Oct. 8, 2026

(54) REUSABLE CLICHÉ TAPE FOR REMOVABLY ATTACHING A FLEXOGRAPHIC PRINTING CLICHÉ

(71) Applicant: Orafol Europe GmbH, Oranienburg (DE)

(72) Inventors: Christoph Stosiek, Berlin (DE); Felix Limberg, Berlin (DE); Tobias Spiess, Bonn (DE); Carsten Böhmer, Berlin (DE)

(21) Appl. No.: 19/482,031

(22) PCT Filed: Apr. 25, 2024
(86) PCT No.: PCT/EP2024/061424

§ 371 Date: Nov. 6, 2025

(30) Foreign Application Priority Data
May 8, 2023 (EP) 23172097.0

(51) Int. Cl. B41N 6/02; B32B 5/18; B32B 7/12; B32B 27/06; B32B 27/36; B32B 27/40; B41F 27/12; B41M 1/04

(52) U.S. Cl. CPC B41N 6/02; B32B 5/18; B32B 7/12; B32B 27/065; B32B 27/36; B32B 27/40; B41F 27/1275; B41M 1/04; B32B 2266/0278; B32B 2307/7376; B32B 2405/00

(57) ABSTRACT

A double-sided reusable cliché tape for removably attaching a flexographic printing cliché on a printing cylinder or printing sleeve is provided. Further, a method for producing printed matter by flexographic printing using the double-sided reusable cliché tape, and use of the double-sided reusable cliché tape for producing printed matter by flexographic printing is provided.

### TECHNICAL FIELD

The present invention relates to the field of flexographic printing. In particular, the present invention relates to a double-sided reusable cliché tape for removably attaching a flexographic printing cliché on a printing cylinder or printing sleeve. Further, the present invention relates to a method for producing printed matter by flexographic printing using the double-sided reusable cliché tape, and use of the double-sided reusable cliché tape for producing printed matter by flexographic printing.

### BACKGROUND

In flexographic printing, the printing cliché, also referred to as printing plate, has to be attached to the printing cylinder or sleeve. In most cases, this is achieved by using a cliché tape, also referred to as adhesive tape or plate mounting tape, between printing cliché and cylinder/sleeve. At the moment, there is a trend in the field of flexographic printing for cliché tapes to be reused more and more frequently. One reason for this is the reduction in run lengths of print jobs, which requires frequent mounting and dismounting of the printing clichés on the printing cylinders equipped with cliché tapes. Companies also want to reduce waste in the interests of sustainability. As an alternative to these cliché tapes, a complete system is available on the market, which is a self-adhesive sleeve, i.e. a ready-made printing cylinder/sleeve permanently provided with a foam and a special photopolymer as an adhesive.

Standard Double-Sided Cliché Tapes The currently available double-sided cliché tapes (e.g. from Lohmann, tesa, 3M, Orafol and other manufacturers) can be reused approximately 1-10 times. When reusing, only the printing cliché is removed after a print job and replaced with a new one. The cliché tape itself remains on the printing cylinder/sleeve. Exemplary build-ups of such double-sided cliché tapes according to the prior art are shown in FIGS. 1 and 2.

To achieve optimal printing results, cliché tapes comprising a foam layer are usually used in flexographic printing. This compressible foam layer is important for printing quality. The foam layers of cliché tapes for mounting of printing clichés are usually made of closed-cell polyethylene (PE) foam, which makes up to 90% of the thickness of the cliché tape. Depending on the application area of the printed product, cliché tapes are divided into two thickness categories: a thickness of 550 μm with a foam layer of around 500 μm for packaging printing and a thickness of 420 μm with a foam layer of around 380 μm for label printing. For both thickness categories, two typical product build-ups for a cliché tape are represented on the market:

In the first variant (see FIG. 1), the foam layer is stabilized on one side with a polyethylene terephthalate (PET) film. As a result, the product is characterized primarily by its guaranteed tear resistance when the cliché tape is removed.

In the second variant (see FIG. 2), the foam layer is reinforced on both sides with a thin layer of polyethylene (PE). Due to the polyethylene reinforcement, the cliché tape is more flexible and is characterized by better conformability even on scratched sleeves or cylinders.

The pressure foams according to variants 1 and 2 are coated on both sides with pressure-sensitive adhesives that have different adhesive strengths. The adhesive on the open side of the cliché tape is optimized for the sleeve/cylinder materials commonly used in flexographic printing. The adhesive on the covered side of the cliché tape is optimized for bonding the printing clichés. The adhesive forces of the two pressure-sensitive adhesives are adjusted so that, in general, the open side adheres more strongly than the covered side. This gradation is necessary to ensure reusability of the cliché tape, where only the printing cliché is removed and replaced by a new one, but the cliché tape remains on the full surface of the cylinder/sleeve. The pressure-sensitive adhesives used are predominantly acrylate pressure-sensitive adhesives (pure acrylates, resin-modified acrylates). Variants with rubber adhesives are also represented on the market. These adhesives lose a little of their initial tackiness after each use due to contamination. Because of their chemical properties, they cannot be reactivated/cleaned. This contamination by dust, grease (used in manual mounting), ink residues, etc. causes the tackiness to drop to a level at which the printing cliché can no longer be held securely on the cliché tape. Both variants of standard cliché tapes can be reused approximately six times before they need to be replaced with a new cliché tape.

### Self-Adhesive Printing Sleeve

As an alternative, a product has been developed that can be reused for several months or even years. This complete system is a ready-made printing cylinder/sleeve with a foam layer and a special photopolymer layer as an adhesive. This system is based on a method of permanently mounting printing clichés on these sleeves without using additional double-sided cliché tapes. These self-adhesive sleeves require a high initial investment and therefore, represent a major hurdle for the customer to switch to this system. Such system is for instance available under the names tesa Twinlock® and Polymount sleeve. An exemplary build-up of such ready-made printing cylinder/sleeve according to the prior art is shown in FIG. 3.

The self-adhesive printing sleeve is an alternative to the cliché tapes described above. The sleeve has an integrated foam layer and eliminates the need for an additional cliché tape. The PU foam is permanently bonded to the cylinder with a pressure-sensitive adhesive. On the other side the polymer is arranged on which the printing cliché is attached. The polymer can be reactivated and can be restored to its original adhesive strength by cleaning the surface with a special solvent.

A disadvantage for many applications is that the printing cylinder must be specially manufactured for the respective process or an existing sleeve must be reworked so that the structure fits the process. The main factor here is the correct overall size of the self-adhesive cylinder. The product is offered with one adhesive strength to the printing cliché and in three different foam hardnesses (soft, medium and hard). 85% of all sleeves or cylinders sold worldwide have a medium foam hardness.

Unlike cliché tapes, this self-adhesive sleeve or cylinder is based on a 1.5 mm thick polyurethane (PU) foam. This means it has three times the thickness of a standard cliché tape. Due to the thicker build-up of PU foam and polymer layer the sleeve or cylinder has to be made smaller to achieve the same print length as before. Further, due to the special structure of the open-cell PU foam and the higher foam thickness, the coated sleeve has different compression properties than a cliché tape. The build-up of the self-adhesive printing sleeve is described in U.S. Pat. Nos. 5,715,750 and 6,085,653.

U.S. Pat. No. 5,715,750 discloses printing form attachment means for removably attaching a flexographic printing form made of a photopolymeric material by adhesion on a plate cylinder of a printing press, characterized in that the printing form attachment means comprises a completely exposed photopolymeric printing form attachment layer made of a photopolymeric material adapted to be located on the plate cylinder for removable adherent attachment of the printing form to the plate cylinder utilizing the adherent and sticky characteristics of the photopolymeric material, as well as a flexible support layer which supports the photopolymeric printing form attachment layer. The photopolymeric printing form attachment layer preferably has a thickness of 1-4 mm and further serves as a kind of resilient layer between the printing form and the printing cylinder. Thickness values for the remaining layers of the printing form attachment means are not disclosed.

U.S. Pat. No. 6,085,653 discloses printing form attachment means for removably attaching a flexographic printing form made of a photopolymeric material by adhesion on a plate cylinder of a printing press, characterized in that the printing form attachment means comprises a treated polymeric printing form attachment layer made of a polymeric material adapted to be located on the plate cylinder for removable adherent attachment of the printing form to the plate cylinder utilizing the sticky and adherent characteristics of the polymeric material, as well as a flexible dimensionally stable support layer which supports the polymeric printing form attachment layer and a resilient foam backing layer on the side of the support layer opposite to the polymeric printing form attachment layer. The polymeric layer has a relatively low hardness and preferably a thickness of 0.5-20 mm. Thickness values for the remaining layers of the printing form attachment means are not disclosed.

It is generally accepted that for performing flexographic printing a compressible layer of a certain thickness has to be present between the printing cylinder and the printing cliché to achieve high quality printing results, in particular for printing on materials with a rough surface. In standard cliché tapes, this is achieved by providing a layer of PE foam of 350-500 μm; and in self-adhesive sleeves by providing a 1.5 mm thick PU foam layer. In U.S. Pat. Nos. 5,715,750 and 6,085,653, a polymeric layer with a relatively high thickness is provided for this purpose, and in U.S. Pat. No. 6,085,653 in addition a resilient foam backing layer is employed. The present inventors have surprisingly found that the thickness of both foam layer and polymeric layer can be significantly reduced while maintaining a high degree of printing quality. Using a foam backing layer and polymeric layer with reduced thickness decreases the amount of material required, which is advantageous both from an ecological and economic point of view. When the layers are made thinner, less chemicals and energy are required during manufacture and less waste is produced when the cliché tape is eventually replaced by a new one.

Further, with a reduced thickness of individual layers, the concept of self-adhesive sleeves can be extended to the use of flexographic cliché tapes. The cliché tapes of the present invention can be used on existing printing cylinders.

Thus, it is an object of the present invention to provide a reusable cliché tape for removably attaching a flexographic printing cliché with high sustainability that enables high printing quality.

### SUMMARY OF THE INVENTION

The present invention provides a hybrid technology, an interface between the classical double-sided cliché tape and the self-adhesive printing sleeve.

In particular, the present invention provides a double-sided reusable cliché tape (1) for removably attaching a flexographic printing cliché on a printing cylinder or printing sleeve, comprising an adhesive layer (2) on the cylinder side, a foam layer (31) comprising a PE or PU foam, a reinforcing layer (4) comprising a polyester film, and a layer of a photopolymer compound (5) on the cliché side. The photopolymer compound is used as a pressure-sensitive adhesive for attaching the printing cliché on the double-sided cliché tape (1) using the adherent and sticky characteristics of the photopolymeric material. The foam layer (31) has a thickness in the range of 150-500 μm.

Further, the present invention provides a double-sided reusable cliché tape (1) for removably attaching a flexographic printing cliché on a printing cylinder or printing sleeve, comprising an adhesive layer (2) on the cylinder side, a film layer (32), and a layer of a photopolymer compound (5) on the cliché side. The photopolymer compound is used as a pressure-sensitive adhesive for attaching the printing cliché on the double-sided cliché tape (1) using the adherent and sticky characteristics of the photopolymeric material. The film layer (32) has a thickness in the range of 23-370 μm.

Further, the present invention provides a method for producing printed matter by flexographic printing comprising the following steps: (i) attaching the adhesive layer (2) of a double-sided reusable cliché tape (1) according to the invention on a printing cylinder or printing sleeve, (ii) attaching a flexographic printing cliché on the layer of a photopolymer compound (5) of the double-sided reusable cliché tape (1) and (iii) producing printed matter on a flexographic printing press. Next (iv) the flexographic printing cliché can optionally be removed from the layer of a photopolymer compound (5) of the double-sided reusable cliché tape (1), and (v) the double-sided reusable cliché tape (1) can optionally be removed from the printing cylinder or printing sleeve. Steps (i) to (iv) can be repeated around 50 times before step (v) has to be performed.

Further, the present invention provides the use of the inventive double-sided reusable cliché tape (1) for producing printed matter by flexographic printing.

Preferred embodiments of the present invention are disclosed in the dependent claims.

According to the present invention, the photopolymer compound is used as a pressure-sensitive adhesive for attaching printing clichés on double-sided cliché tapes. Such a cliché tape combines the advantages of a standard cliché tape with the durability of the self-adhesive printing sleeve. The cliché tape of the present invention can be reused about 50 times without the compressibility of the foam suffering noticeably or the adhesive force of the photopolymer compound to the printing cliché decreasing too much. The consistent adhesive strength of the photopolymer compound to the printing cliché is ensured by the possibility of cleaning the layer of a photopolymer compound. In contrast to conventional pressure-sensitive adhesives, the photopolymer compound is not soluble in solvents and does not swell, and thus the surface can be cleaned/reactivated relatively easily with solvents.

### BRIEF DESCRIPTION OF THE DRAWINGS

FIG. 1 illustrates the build-up of a standard cliché tape. This cliché tape comprises layers of PE foam (B), laminating adhesive (C) and PET film (D) placed on top of each other. Both on the cylinder side and the printing cliché side, an adhesive layer (A, E) for fixing on the printing cylinder and for fixing the printing cliché is provided. A cover layer (F) can be provided on top of the adhesive layer E. Standard values for the thickness of each layer are as follows:

| | Layer | thickness | |
|---|---|---|---|
| A | adhesive layer, cylinder side | 25 | μm |
| B | PE foam | 480 | μm |
| C | laminating adhesive | 5 | μm |
| D | PET film | 19 | μm |
| E | adhesive layer, cliché side | 25 | μm |
| F | cover layer | 120 | μm |

FIG. 2 illustrates the build-up of another standard cliché tape. This tape comprises a layer of PE foam (B), sandwiched between two layers of PE film (G). Both on the cylinder side and the printing cliché side, an adhesive layer (A, E) for fixing on the printing cylinder and for fixing the printing cliché is provided. A cover layer (F) can be provided on top of the adhesive layer E. Standard values for the thickness of each layer are as follows:

| | Layer | thickness | |
|---|---|---|---|
| A | adhesive layer, cylinder side | 25 | μm |
| G | PE film | 500 | μm |
| B | PE foam | | |
| G | PE film | | |
| E | adhesive layer, cliché side | 25 | μm |
| F | cover layer | 120 | μm |

FIG. 3 illustrates the build-up of a standard self-adhesive printing sleeve. This system comprises a printing cylinder (H) and layers of PU foam (B), laminating adhesive (C) and PET film (D) placed on top of each other. On the cylinder side, an adhesive layer (A) for fixing on the printing cylinder is provided. The layered structure is permanently connected with the printing cylinder. For fixing the printing cliché, a layer of photopolymer (I) is provided on the printing cliché side. A cover layer (F) can be provided on top of the photopolymer I. Standard values for the thickness of each layer are as follows:

| | Layer | thickness | |
|---|---|---|---|
| H | cylinder | >2000 | μm |
| A | adhesive layer, cylinder side | 25 | μm |
| B | PU foam | 1500 | μm |
| C | laminating adhesive | 25 | μm |
| D | PET film | 120 | μm |
| I | photopolymer | 400 | μm |
| F | cover layer | 120 | μm |

FIG. 4 illustrates an exemplary build-up of the double-sided reusable cliché tape according to the present invention. This cliché tape comprises an PE or PU foam layer (31), a reinforcing polyester film layer (4), a layer of a photopolymer compound (5) and adhesive layers (2) and (6) on the cylinder side and between layers (31) and (4). The layer of a photopolymer compound (5) is used for fixing the printing cliché. A cover layer (7) can be provided on top of the layer of a photopolymer compound (5). Exemplary values for the thickness of each layer are as follows:

| | Layer | thickness | |
|---|---|---|---|
| 2 | adhesive layer, cylinder side | 25 | μm |
| 31 | PE or PU foam | 310 | μm |
| 6 | adhesive | 25 | μm |
| 4 | polyester film, e.g. PET film | 36 | μm |
| 5 | photopolymer | 150 | μm |
| 7 | cover layer | 120 | μm |

FIG. 5 illustrates an exemplary preferred build-up of the double-sided reusable cliché tape according to the present invention. This cliché tape comprises the same layers as shown in FIG. 4 and additionally, a PE film (8) between the adhesive layer (2) on the cylinder side and the PE or PU foam (31). Exemplary values for the thickness of each layer are as follows:

| | Layer | thickness | |
|---|---|---|---|
| 2 | adhesive layer, cylinder side | 25 | μm |
| 8 | PE film | 310 | μm |
| 31 | PE or PU foam | | |
| 6 | adhesive | 25 | μm |
| 4 | polyester film, e.g. PET film | 36 | μm |
| 5 | photopolymer | 150 | μm |
| 7 | cover layer | 120 | μm |

FIG. 6 shows the dot gain curve for a fingerprint test using a standard self-adhesive printing sleeve (Polymount).

FIG. 7 shows the dot gain curve for a fingerprint test using a cliché tape according to the present invention.

FIG. 8 shows the dot gain curves for fingerprint tests using classic, foam-supported adhesive tapes available on the market.

### DETAILED DESCRIPTION

As is described in detail above, there are two systems for mounting a printing cliché on a printing cylinder or sleeve known from the prior art: cliché tapes for flexographic printing with PE foam that are cheap but not very sustainable, and self-adhesive printing sleeves, which have long durability, but are expensive and not very flexible in their application.

The present invention provides a double-sided cliché tape that can be reused about 50 times, making it interesting for many users because it does not require the high invention costs of the self-adhesive printing sleeves. The cliché tape comprises an adhesive layer (2) on the cylinder side, a foam layer (31) comprising a PE or PU foam, a reinforcing layer (4) comprising a polyester film, and a layer of a photopolymer compound (5) on the cliché side. Preferably, the foam layer (31) and the reinforcing layer (4) are arranged such that the foam layer (31) is closer to the cylinder side and the reinforcing layer (4) is closer to the cliché side. The foam layer can comprise a PE foam or a PU foam, but a PU foam is preferred. Even more preferably, the foam layer consists of PU foam. Preferably, the reinforcing layer (4) comprises a PET film. Even more preferably, the reinforcing layer consists of a PET film. Preferably, the double-sided reusable cliché tape (1) further comprises an additional adhesive layer (6), arranged between the foam layer (31) and the reinforcing layer (4). Preferably, the adhesive layer (2) and/or the adhesive layer (6) comprise a pressure-sensitive adhesive. Suitable examples are pressure-sensitive adhesives on acrylate basis, e.g. pure acrylates, resin-modified acrylates, pressure-sensitive adhesives on rubber basis, polyurethane based adhesives, and further types of adhesives that are commonly used in that field and known to the skilled person. Preferably, the double-sided reusable cliché tape (1) further comprises a cover layer (7), arranged on top of the layer of a photopolymer compound (5) on the cliché side. Suitable cover layers than protect the photopolymer compound and can be peeled off easily are commercially available and known to the skilled person. The adhesive layer (2) on the cylinder side can be optimized for the sleeve/cylinder materials commonly used in flexographic printing. It ensures sufficiently high adhesion with simultaneous residue-free removability. Preferably, the adhesion between cylinder/sleeve and adhesive layer (2) is stronger than the adhesion between the layer of a photopolymer compound (5) and printing cliché.

Preferably, between the adhesive layer (2) on the cylinder side and the foam layer (31), an additional layer of a polyolefin film (8) is arranged. Preferably, the polyolefin film (8) is a polyethylene film (PE). The PE can be any type of commercially available PE, such as High Density Polyethylene (PE-HD), Low Density Polyethylene (PE-LD) or Linear Low Density Polyethylene (PE-LLD). Preferably, the polyolefin film (8) has a thickness in the range of 5-30 μm, preferably 7 to 25 μm, more preferably 10 to 20 μm. Preferably, the polyolefin film (8) is a PE layer with a basis weight in the range of 5-60 g/m², more preferably 10-50 g/m², more preferably 20-40 g/m².

The optional coating of the foam layer (31) with the polyolefin film layer (8) provides a more stable outer surface of the foam layer (31), which can have a positive effect on the dismantling behaviour after use by reducing the tendency of the foam to tear. The polyolefin film layer (8) is applied by co-extrusion and the surface of the foam layer (31) and the polyolefin film layer (8) fuse together. The additional polyolefin (e.g., PE) layer (8) on the cylinder side of the foam layer (31) leads to improved thickness tolerance and reduced roughness of the cliché tape, while small unevenness in the carrier foam layer (31) are compensated for by the additional film (8). At the same time, the product remains flexible and can conform very well to different sleeve surfaces. This is particularly useful for scratched sleeves and cylinders. The so-called foaming skin of the carrier foam layer (31) is also thickened by the polyolefin (PE) film (8). This thickening ensures greater stability/strength of the foam layer (31) against possible tearing during the removal process and thus ensures residue-free removal of the cliché tape from critical substrates. Such PE coatings are known from commercially available standard cliché tapes to improve the overall strength. However, since these standard cliché tapes are reused approximately only 1-10 times, there is in general no problem with foam breakage during disassembly. In contrast, for the cliché tape of the present invention, which can be reused about 50 times, a reinforcing of the foam layer (31) with a polyolefin film (8) to enable a secure dismantling of the cliché tape without breaking of the foam is advantageous.

According to the invention, the foam layer (31) has a thickness in the range of 150-500 μm. Preferably, the foam layer (31) has a thickness in the range of 150-370 μm, more preferably 270-350 μm, even more preferably 300-320 μm, which provides an optimum balance between material requirements and printing quality. Preferably, if the cliché tape comprises the polyolefin film (8), the above values refer to the total thickness of foam layer (31) and polyolefin layer (8). Preferably, such printing cliché is used for packaging printing.

Alternatively, the foam layer (31) preferably has a thickness in the range of 150-250 μm, more preferably 175-225 μm, even more preferably 175-200 μm, which provides an optimum balance between material requirements and printing quality. Preferably, if the cliché tape comprises the polyolefin film (8), the above values refer to the total thickness of foam layer (31) and polyolefin layer (8). Preferably, such printing cliché is used for label printing.

The adhesive layers (2) and (6), the reinforcing layer (4), the layer of a photopolymer compound (5) and the cover layer (7) can each have a thickness as commonly used, e.g. the thickness values as disclosed above for standard cliché tapes or self-adhesive printing sleeves. However, to achieve a printing cliché with high sustainability that can provide high-quality printing results, it is preferred to adjust the thicknesses of these layers as follows:

Preferably, the reinforcing layer (4) has a thickness in the range of 19-100 μm, more preferably 30-70 μm, even more preferably 30-40 μm. Preferably, the layer of a photopolymer compound (5) has a thickness in the range of 100-350 μm, preferably 130-250 μm, more preferably 140-175 μm. Preferably, the adhesive layer (2) and/or the adhesive layer (6) have a thickness in the range of 15-35 μm, more preferably 20-35 μm, even more preferably 20-30 μm. Preferably, the cover layer (7) has a thickness in the range of 50-150 μm, more preferably 100-130 μm, even more preferably 110-130 μm.

In the following table, exemplarily preferred combinations of ranges for the thickness of each layer of the double-sided cliché tape according to the present invention are provided. Preferably, such printing cliché is used for packaging printing.

| | | | | adhesive | | | | layer of a | | | |
|---|---|---|---|---|---|---|---|---|---|---|---|
| adhesive | | foam layer | | layer (6) | | reinforcing | | photopolymer | | cover layer (7) | |
| layer (2) | | (31) * | | (optional) | | layer (4) | | compound (5) | | (optional) | |
| 15-35 | μm | 150-500 | μm | 15-35 | μm | 19-100 | μm | 100-350 | μm | 50-150 | μm |
| 20-35 | μm | 270-350 | μm | 20-35 | μm | 30-70 | μm | 130-250 | μm | 100-130 | μm |
| 20-30 | μm | 300-320 | μm | 20-30 | μm | 30-40 | μm | 140-175 | μm | 110-130 | μm |
| 25 | μm | 310 | μm | 25 | μm | 36 | μm | 150 | μm | 120 | μm |

* If the cliché tape comprises the polyolefin film (8), the indicated values preferably refer to the total thickness of foam layer (31) and polyolefin layer (8).

Alternative exemplarily preferred combinations of ranges for the thickness of each layer of the double-sided cliché tape according to the present invention are provided in the following table. Preferably, such printing cliché is used for label printing.

| | | | | adhesive | | | | layer of a | | | |
|---|---|---|---|---|---|---|---|---|---|---|---|
| adhesive | | foam layer | | layer (6) | | reinforcing | | photopolymer | | cover layer (7) | |
| layer (2) | | (31)* | | (optional) | | layer (4) | | compound (5) | | (optional) | |
| 15-35 | μm | 150-250 | μm | 15-35 | μm | 19-100 | μm | 100-350 | μm | 50-150 | μm |
| 20-35 | μm | 175-225 | μm | 20-35 | μm | 30-70 | μm | 130-250 | μm | 100-130 | μm |
| 20-30 | μm | 175-200 | μm | 20-30 | μm | 30-40 | μm | 140-175 | μm | 110-130 | μm |
| 25 | μm | 185 | μm | 25 | μm | 36 | μm | 150 | μm | 120 | μm |

*If the cliché tape comprises the polyolefin film (8), the indicated values preferably refer to the total thickness of foam layer (31) and polyolefin layer (8).

Alternatively, the double-sided cliché tape according to the present invention comprises a foil layer (32) instead of the foam layer (31). Preferred combinations of ranges for the thickness of each layer of this double-sided cliché tape according to the present invention are provided in the following table.

| adhesive layer | | | | layer of a photopolymer | | cover layer (7) | |
|---|---|---|---|---|---|---|---|
| (2) | | foil layer (32) | | compound (5) | | (optional) | |
| 15-35 | μm | 23-370 | μm | 100-350 | μm | 50-150 | μm |
| 20-35 | μm | 70-350 | μm | 130-250 | μm | 100-130 | μm |
| 20-30 | μm | 100-200 | μm | 140-175 | μm | 110-130 | μm |
| 25 | μm | 125 | μm | 150 | μm | 120 | μm |

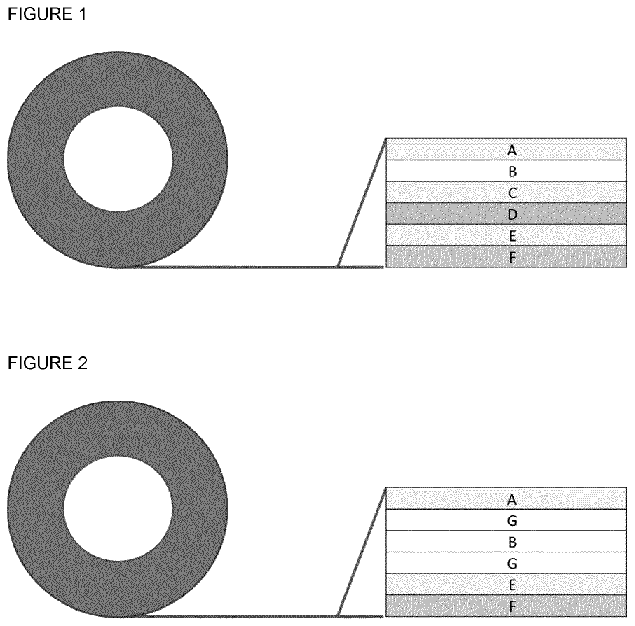

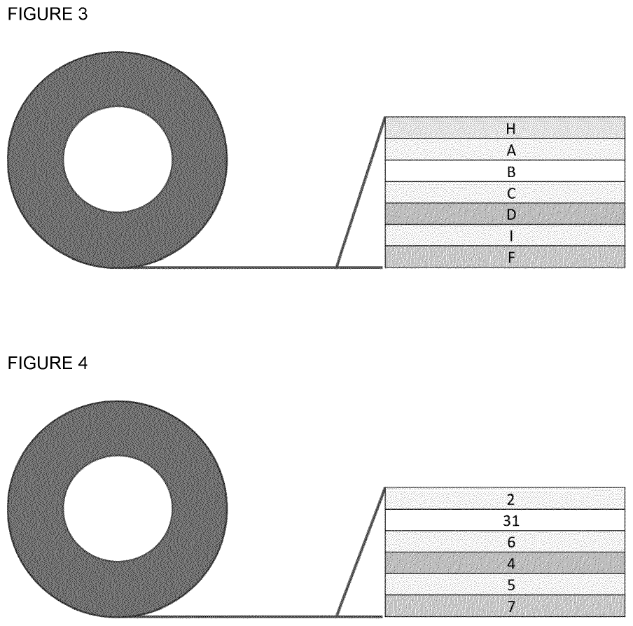

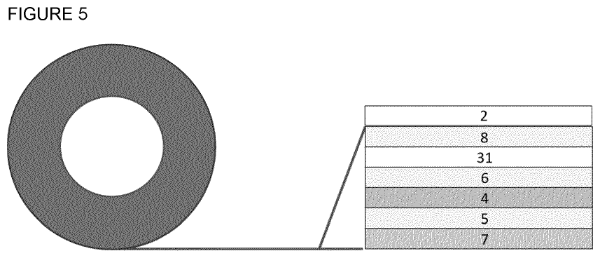

Advantageous properties of the double-sided cliché tape according to the present invention are a high flexibility combined with a high reusability. In contrast to the self-adhesive printing sleeves, the cliché tape of the present invention can be used on any printing cylinder/sleeve. It is independent of width and diameter and can be used on all common printing machines (which use sleeves/cylinders). In the event of damage, the cliché tape of the present invention can simply be replaced. With the self-adhesive printing sleeves, the complete sleeve must be sent in for reworking. Due to the use of the photopolymer compound, the reusability of the cliché tape of the present invention is significantly higher than that of standard cliché tapes in the build-ups 1 and 2 described above and shown in FIGS. 1 and 2. Laboratory measurements have shown that the adhesive force of a printing cliché on the layer of a photopolymer compound of the present invention remains constant even after 12 times of adhesion. When using commercially available standard cliché tapes, the adhesive force to the printing cliché decreases continuously after only the second use until a level is reached at which the cliché is no longer held securely. In addition, the adhesive force of the photopolymer compound can be restored to the initial level by cleaning (activation) with a suitable solvent.

The double-sided cliché tape according to the present invention has a layered structure. Unlike standard cliché tapes on the market, the double-sided cliché tape according to the present invention preferably uses a polyurethane (PU) foam backing, which has a significantly longer service life against compression than polyethylene (PE) foam backing. The carrier foam used in the present invention is thinner than in commercially available cliché tapes, where the foam usually has a thickness of 500 μm, while maintaining comparable print quality. The pressure-sensitive adhesive for attaching the printing cliché in the double-sided cliché tape according to the present invention is a reactivatable photopolymer and not an acrylate adhesive as in standard cliché tapes.

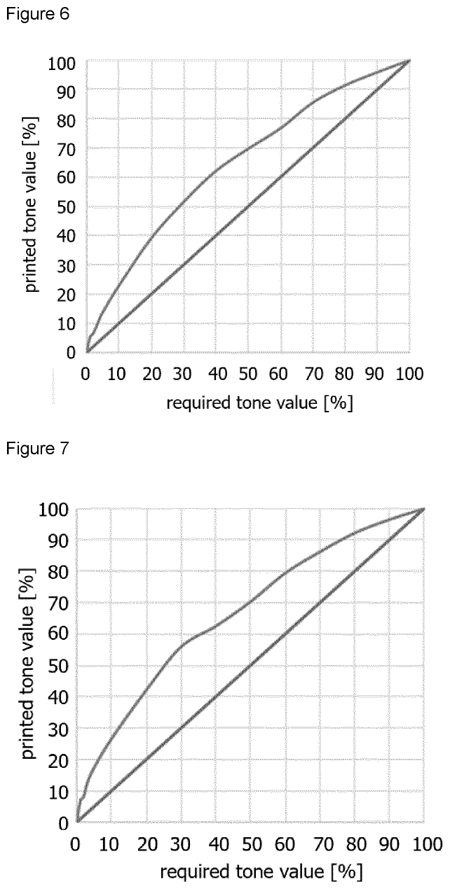

The cliché tape of the present invention is a flexible cliché tape that can be used on any commercially available cylinder/sleeve. It preferably has a total thickness of around 550 μm or 420 μm (thickness without cover layer). These total thicknesses correspond to the values typically used for printing clichés for packaging printing (total thickness of 550 μm) and for label printing (total thickness of 420 μm). Thus, the cliché tapes of the present invention can be used on existing printing cylinders. With the self-adhesive printing sleeves, the cylinders/sleeves used must each be adapted to the required total circumference by grinding or milling. The thickness of the reinforcing layer comprising a polyester film, preferably a PET film, in the cliché tape of the present invention is preferably significantly thinner than in the self-adhesive printing sleeve, where this thickness is about 120 μm. Further, the thickness of the photopolymer layer in the self-adhesive printing sleeve is around 400 μm. Thus, the thickness of the polymer layer of the cliché tape of the present invention is preferably significantly lower than in the self-adhesive printing sleeve but has comparable adhesive strength. Also, the thicknesses of the PU carrier foams differ significantly from the self-adhesive printing sleeve (thickness of about 1500 μm). However, the print quality and dot gain are comparable for both products despite the clear differences in thickness, as is shown in Example B below and FIGS. 6 and 7.

The adhesive strength of the photopolymer layer can be adjusted by the polymer thickness, the polymer composition and/or the degree of polymerization to ensure sufficiently high adhesion, prevention of detachment of the printing cliché edges due to restoring forces, and residue-free removability of the printing cliché without the risk of distortion/stretching. In addition to the photopolymer layer, which can be reused almost any number of times, the foam layer, which is very important for print quality, is preferably made of a high-quality and durable polyurethane foam.

In summary, the following advantages result from the cliché tape according to the present invention compared to the standard cliché tapes and standard self-adhesive printing sleeves:

Advantages compared to the standard cliché tapes:
Reduction in the amount of cliché tape required
Significantly reduced mounting time (since no double-sided cliché tape needs to be mounted on the printing cylinder after initial mounting)
Significantly increased reusability due to the use of the photopolymer
Sustainable product
More eco-friendly product, because polymer without solvent during coating and without residual solvent is used

Advantages compared to the standard self-adhesive printing sleeves:
Suitable for all cylinder types and circumferences
More flexible in foam hardness than self-adhesive printing sleeves
Significantly lower acquisition costs
More attractive to customers because it is a consumable product (invest. vs. consumable)
Lower inventory costs
Shorter delivery times because it is not a customized product

### Composition of the Photopolymer Compound

The reactivatable photopolymer compound according to the present invention has a constant adhesive strength to the printing cliché that can be reactivated by suitable cleaning agents. Exemplarily cleaning agents are ethyl acetate, alcohols, or acetone.

Preferably, the photopolymer compound is obtained by polymerizing a mixture comprising at least one hydroxyl-terminated polybutadiene, and at least one isocyanate source. Preferably, the photopolymer compound is obtained by polymerizing a mixture comprising at least one hydroxyl-terminated polybutadiene, optionally at least one mono-, di-, tri- or polyfunctional (meth)acrylate, e.g. EHA, LMA or AA, as reactive diluent and at least one isocyanate source. To this mixture, a capping solution is added that can comprise methacrylates (for example HPMA), a suitable polymerization initiator as well as a suitable catalyst (capping agent) and antioxidant, if desired. The composition of the mixture for preparing the photopolymer compound is preferably as follows:

| | amount 1 in | amount 2 | amount 3 in | amount 4 in |
|---|---|---|---|---|
| Component | wt % | in wt % | wt % | wt %. |
| Hydroxyl- | 95-40, | 90-80 | 80-65 | 75-70 |
| terminated | preferably | | | |
| polybutadiene | 90-40 | | | |
| Mono/Di/Tri/Poly | 55-0, | 5-0 | 25-10 | 20-15 |
| functional | preferably | | | |
| methacrylate or | 55-5 | | | |
| acrylate (reactive | | | | |
| diluent) | | | | |
| Methacrylate (in | 10-0, | 10-5 | 10-5 | 10-5 |
| capping solution) | preferably | | | |
| | 10-−5 | | | |
| Isocyanate | 40-1, | 10-1 | 10-1 | 5-1 |
| source | preferably | | | |
| | 15-−1 | | | |
| Antioxidant | 1-0, | 0.25-0.05 | 0.25-0, | 0.2-0, |
| | preferably | | preferably | preferably |
| | 1-0.3 | | 0.25-0.05 | 0.2-0.1 |
| Polymerization | 3-0, | 3-1 | 2.5-0, | 2-0, |
| initiator | preferably | | preferably | preferably |
| | 3-0.5 | | 2.5-0.5 | 2-1 |
| Catalyst | 0.02-0.05 | 0.01-0.05 | 0.015-0.05 | 0.01-0.05 |

The above weight percentages refer to the photopolymer composition. The photopolymer composition can be composed from the weight percentages indicated in each column in such a way that the total sum adds up to 100%. The prerequisite for this is in each case that the stated components are within the stated percentage ranges. Suitable hydroxyl-terminated polybutadienes, mono-, di-, tri- or polyfunctional methacrylates and acrylates, antioxidants, polymerization initiators (photo initiators) and catalysts are commercially available and known to the skilled person.

Hydroxyl-terminated polybutadienes are commercially available. They are obtained by polymerizing butadiene and have hydroxyl groups on both ends as the active sites.

Suitable mono-, di-, tri- or polyfunctional methacrylates and acrylates are for instance acrylic acid; methacrylic acid; salts, esters and conjugate bases of acrylic acid; salts, esters and conjugate bases of methacrylic acid; e.g. methyl (meth)acrylate, ethyl (meth)acrylate, lauryl methacrylate, ethylhexyl acrylate, hydroxypropyl methacrylate, ethylene-methyl acrylate, 2-hydroxyethyl acrylate, hydroxyethyl methacrylate, butyl acrylate, trimethylolpropane triacrylate and mixtures thereof. Preferred examples are acrylic acid (AA), ethylhexyl acrylate (EHA), hydroxypropyl methacrylate (HPMA) and lauryl methacrylate (LMA) and mixtures thereof. Preferably, an ester of acrylic acid (e.g. 2-ethylhexyl acrylate) and acrylic acid are used in combination in a weight ratio of preferably 10:1. Thus, the tackiness and anchoring of the polymer to carrier films can be improved. Further, the monomers may already be partially polymerized for better handling and viscosity adjustment.

Suitable isocyanate sources are for instance diisocyanate compounds, such as toluene diisocyanate and diphenylmethane diisocyanate, e.g. 2,4-toluene diisocyanate, 2,6-toluene diisocyanate, 4,4-diphenylmethane diisocyanate, 2,4′-diphenylmethane diisocyanate and mixtures thereof.

A suitable antioxidant is for instance BHT (butyl hydroxytoluene). A suitable polymerization initiator is for instance BIBE (benzoin isobutyl ether). A suitable catalyst (capping agent) is for instance DBTDL (dibutyltin dilaurate).

Commercial sources of these components are for instance:

Hydroxyl-terminated polybutadiene: Krasol and Poly BD (Cray Valley), Nisso-GI and Nisso G (Nippon Soda Co., LTD.), Hypro (Emerald Performance Materials).

Mono/Di/Tri/Poly functional methacrylates and acrylates: e.g. HPMA, EHA, AA, LMA (Sartomer, BASF, Alfa Chemistry, GEO Specialty Chemicals, Inc.) Isocyanate source: Mondur TD80 (Covestro) (mixture of 2,4- and 2,6-toluene diisocyanate), Isonate (DOW Chemical) (diphenylmethane diisocyanates)

Antioxidant BHT: Vulkanox BHT solid (Lanxess)

Polymerization initiators BIBE: BENZOIN ISOBUTYL ETHER (TCI Europe)

Catalyst DBTDL: BNT-CAT 428 (BNT Chemicals GmbH)

### EXAMPLES

The present invention is further illustrated in the following examples, which are provided by way of illustration and not by way of limitation.

Abbreviations:

| | |
|---|---|
| AA | acrylic acid |
| BHT | butyl hydroxytoluene |
| BIBE | benzoin isobutyl ether |
| DBTDL | dibutyltin dilaurate |
| EHA | ethylhexyl acrylate |
| HPMA | hydroxypropyl methacrylate |
| LMA | lauryl methacrylate |

### Example A: Synthesis of Cliché Tapes

In Tables 1 to 5, 6-1 and 6-2, exemplarily compositions for photopolymer compositions to be employed in the cliché tapes according to the present invention are shown. To prepare a photopolymer composition, the following general reaction procedure is followed:

### General Reaction Procedure for Producing Photopolymer Composition

The indicated amounts of the hydroxyl-terminated polybutadienes are stirred together with the reactive diluents, if desired, (acrylates or methacrylates, for example LMA, EHA, AA) and an antioxidant, if desired, (for example BHT) for 24 h under nitrogen atmosphere. Subsequently, the polyaddition reaction takes place by isocyanate addition under heat generation. After about 7 h, the capping solution that can comprise methacrylates (for example HPMA) and a capping agent (for example DBTDL) and the photoinitiator (for example BIBE) are added and the nitrogen atmosphere is exchanged for air atmosphere. This mixture is kept at approximately 55° C. overnight.

### Preparation of Cliché Tape

A layered structure of adhesive layer (2), foam layer (31), reinforcing layer (4) and optional adhesive layer (6) with each layer in the desired thickness is produced in a conventional manner. These layers are commercially available or can be prepared according to standard preparation methods. Next, the photopolymer composition is applied in the desired thickness onto the reinforcing layer and cured by light, preferably UV light to produce the layer of a photopolymer compound (5). If desired, a commercially available cover layer (7) is placed on top of the layer of a photopolymer compound (5) in a conventional manner.

Table 1 lists various compositions comprising a variety of commercially available hydroxyl-terminated polybutadienes in combination with an isocyanate source (Mondur TD80) and a catalyst (DBTDL) that can serve as base polyurethane components.

Table 2 lists various blends of hydroxyl-terminated polybutadienes which, after polymerization by a suitable isocyanate source, e.g. Mondur TD 80, result in polyurethanes with different Shore hardness, strength, toughness, etc.

Table 3 lists various blends of hydroxyl-terminated polybutadienes which, after polymerization by a suitable isocyanate source, e.g. Isonate 50 OP, result in polyurethanes with different Shore hardness, strength, toughness, etc.

Table 4 lists various blends of hydroxyl-terminated polybutadienes which, after polymerization by a suitable isocyanate source, e.g. Isonate 143L, result in polyurethanes with different Shore hardnesses, strengths, toughnesses, etc.

Table 5 lists various blends of hydroxyl-terminated polybutadienes which, after polymerization by a suitable isocyanate source, e.g. Isonate 240, result in polyurethanes with different Shore hardness, strength, toughness, etc.

Tables 6-1 and 6-2 lists various blends of hydroxyl-terminated polybutadienes that result in polyurethane-based photopolymers with different tackiness levels. The use of methacrylates allows the polymer to be cured by UV radiation. By adding a mixture of 2-ethylhexyl acrylate or a similar acrylic acid ester with acrylic acid in a weight ratio of preferably 10:1 to the example formulations, the tackiness and anchoring of the polymer to carrier films can be improved. The monomers may already be partially polymerized for better handling and viscosity adjustment.

TABLE 1
Photopolymer compositions 1-15.

| | Number | 1 | 2 | 3 | 4 | 5 | 6 | 7 | 8 |
|---|---|---|---|---|---|---|---|---|---|
| hydroxyl-terminated | Nisso GI-3000 | 94.48 | | | | | | | |
| polybutadiene | Nisso GI-2000 | | 91.95 | | | | | | |
| | Nisso GI-1000 | | | 88.79 | | | | | |
| | Nisso G-3000 | | | | 94.48 | | | | |
| | Nisso G-2000 | | | | | 91.95 | | | |
| | Nisso G-1000 | | | | | | 88.03 | | |
| | Krasol LBH 2000 | | | | | | | 91.14 | |
| | Krasol LBHP 2000 | | | | | | | | 91.47 |
| | Krasol LBH 3000 | | | | | | | | |
| | Krasol LBHP 3000 | | | | | | | | |
| | Poly bd R45HTLO | | | | | | | | |
| | Poly bd R45V | | | | | | | | |
| | Hypro 2800x95 | | | | | | | | |
| | Hypro 1200x90 | | | | | | | | |
| | Poly bd R20LM | | | | | | | | |
| Isocyanate | Mondur TD 80 | 5.50 | 8.03 | 11.20 | 5.50 | 8.03 | 11.96 | 8.84 | 8.52 |
| source | | | | | | | | | |
| Catalyst | DBTDL | 0.015 | 0.015 | 0.015 | 0.015 | 0.015 | 0.015 | 0.015 | 0.015 |

| | Number | 9 | 10 | 11 | 12 | 13 | 14 | 15 |
|---|---|---|---|---|---|---|---|---|
| hydroxyl-terminated | Nisso GI-3000 | | | | | | | |
| polybutadiene | Nisso GI-2000 | | | | | | | |
| | Nisso GI-1000 | | | | | | | |
| | Nisso G-3000 | | | | | | | |
| | Nisso G-2000 | | | | | | | |
| | Nisso G-1000 | | | | | | | |
| | Krasol LBH 2000 | | | | | | | |
| | Krasol LBHP 2000 | | | | | | | |
| | Krasol LBH 3000 | 93.54 | | | | | | |
| | Krasol LBHP 3000 | | 93.92 | | | | | |
| | Poly bd R45HTLO | | | 91.13 | | | | |
| | Poly bd R45V | | | | 91.14 | | | |
| | Hypro 2800x95 | | | | | 91.13 | | |
| | Hypro 1200x90 | | | | | | 81.51 | |
| | Poly bd R20LM | | | | | | | 82.11 |
| Isocyanate | Mondur TD 80 | 6.45 | 6.07 | 8.86 | 8.84 | 8.86 | 18.48 | 17.88 |
| source | | | | | | | | |
| Catalyst | DBTDL | 0.015 | 0.015 | 0.015 | 0.015 | 0.015 | 0.015 | 0.015 |

Rounded composition data in each case in percent by weight. The parts by weight of the individual components add up to 100. The indicated amounts of the hydroxyl-terminated polybutadienes and isocyanate source are mixed according to the general reaction procedure. To the obtained compositions, a capping solution that can comprise 6-7 parts by weight (based on 100 parts by weight of the above compositions) methacrylates (for example HPMA), the indicated amount of capping agent (DBTDL) and 1-3 parts by weight (based on 100 parts by weight of the above compositions) of photoinitiator (for example BIBE) may be added.

TABLE 2
Photopolymer compositions 16-31.

| | Number | 16 | 17 | 18 | 19 | 20 | 21 | 22 | 23 |
|---|---|---|---|---|---|---|---|---|---|
| hydroxyl-terminated | Nisso GI-3000 | 78.84 | 78.40 | | | | | | |
| polybutadiene | Nisso GI-2000 | | | | | 71.30 | 70.76 | | |
| | Nisso GI-1000 | | | | | | | | |
| | Nisso G-3000 | | | | | | | | |
| | Nisso G-2000 | | | | | | | | |
| | Nisso G-1000 | | | | | | | | |
| | Krasol LBH 2000 | | | | | | | | |
| | Krasol LBHP 2000 | | | | | | | 69.96 | 69.41 |
| | Krasol LBH 3000 | | | | | | | | |
| | Krasol LBHP 3000 | | | 77.04 | 76.58 | | | | |
| | Poly bd R45HTLO | | | | | | | | |
| | Poly bd R45V | | | | | | | | |
| | Hypro 2800x95 | | | | | | | | |
| | Hypro 1200x90 | 13.50 | | 14.64 | | 18.31 | | 19.17 | |
| | Poly bd R20LM | | 13.98 | | 15.15 | | 18.92 | | 19.80 |
| Isocyanate | Mondur TD 80 | 7.65 | 7.61 | 8.30 | 8.25 | 10.37 | 10.30 | 10.86 | 10.78 |
| source | | | | | | | | | |
| Catalyst | DBTDL | 0.015 | 0.015 | 0.015 | 0.015 | 0.015 | 0.015 | 0.015 | 0.015 |
| | Number | 24 | 25 | 26 | 27 | 28 | 29 | 30 | 31 |
| hydroxyl-terminated | Nisso GI-3000 | | | | | 66.79 | | | |
| polybutadiene | Nisso GI-2000 | | | | | | | | |
| | Nisso GI-1000 | | | | | | | 41.13 | |
| | Nisso G-3000 | | | | | | | | 66.82 |
| | Nisso G-2000 | | | | | | 57.32 | | |
| | Nisso G-1000 | 61.49 | 60.88 | | | | | | |
| | Krasol LBH 2000 | | | | | 26.72 | | | |
| | Krasol LBHP 2000 | | | | | | | | |
| | Krasol LBH 3000 | | | | | | | 50.21 | |
| | Krasol LBHP 3000 | | | | | | | | |
| | Poly bd R45HTLO | | | | | | 34.32 | | |
| | Poly bd R45V | | | 69.09 | 68.54 | | | | |
| | Hypro 2800x95 | | | | | | | | 26.68 |
| | Hypro 1200x90 | 24.57 | | 19.72 | | | | | |
| | Poly bd R20LM | | 25.32 | | 20.36 | | | | |
| Isocyanate | Mondur TD 80 | 13.92 | 13.78 | 11.17 | 11.09 | 6.48 | 8.34 | 8.65 | 6.48 |
| source | | | | | | | | | |
| Catalyst | DBTDL | 0.015 | 0.015 | 0.015 | 0.015 | 0.015 | 0.015 | 0.015 | 0.015 |

Rounded composition data in each case in percent by weight. The parts by weight of the individual components add up to 100. The indicated amounts of the hydroxyl-terminated polybutadienes and isocyanate source are mixed according to the general reaction procedure. To the obtained compositions, a capping solution that can comprise 6-7 parts by weight (based on 100 parts by weight of the above compositions) methacrylates (for example HPMA), the indicated amount of capping agent (DBTDL) and 1-3 parts by weight (based on 100 parts by weight of the above compositions) of photoinitiator (for example BIBE) may be added.

TABLE 3
Photopolymer compositions 32-46.

| | Number | 32 | 33 | 34 | 35 | 36 | 37 | 38 | 39 |
|---|---|---|---|---|---|---|---|---|---|
| hydroxyl-terminated | Nisso GI-3000 | 92.25 | | | | | | | |
| polybutadiene | Nisso GI-2000 | | 88.81 | | | | | | |
| | Nisso GI-1000 | | | 84.61 | | | | | |
| | Nisso G-3000 | | | | | | | | |
| | Nisso G-2000 | | | | | | | | |
| | Nisso G-1000 | | | | 83.62 | | | | |
| | Krasol LBH 2000 | | | | | 87.72 | | | |
| | Krasol LBHP 2000 | | | | | | | | |
| | Krasol LBH 3000 | | | | | | 90.96 | | |
| | Krasol LBHP 3000 | | | | | | | 91.47 | |
| | Poly bd R45HTLO | | | | | | | | |
| | Poly bd R45V | | | | | | | | 87.72 |
| | Hypro 2800x95 | | | | | | | | |
| | Hypro 1200x90 | | | | | | | | |
| | Poly bd R20LM | | | | | | | | |
| Isocyanate | Isonate 50OP | 7.74 | 11.18 | 15.38 | 16.37 | 12.27 | 9.03 | 8.52 | 12.27 |
| source | | | | | | | | | |
| Catalyst | DBTDL | 0.015 | 0.015 | 0.015 | 0.015 | 0.015 | 0.015 | 0.015 | 0.015 |

| | Number | 40 | 41 | 42 | 43 | 44 | 45 | 46 |
|---|---|---|---|---|---|---|---|---|
| hydroxyl-terminated | Nisso GI-3000 | | 64.93 | | | | 76.26 | 75.86 |
| polybutadiene | Nisso GI-2000 | | | | | | | |
| | Nisso GI-1000 | | | | 39.62 | | | |
| | Nisso G-3000 | | | | | 64.97 | | |
| | Nisso G-2000 | | | 55.29 | | | | |
| | Nisso G-1000 | | | | | | | |
| | Krasol LBH 2000 | | 25.97 | | | | | |
| | Krasol LBHP 2000 | | | | | | | |
| | Krasol LBH 3000 | | | | 48.36 | | | |
| | Krasol LBHP 3000 | | | | | | | |
| | Poly bd R45HTLO | | | 33.11 | | | | |
| | Poly bd R45V | | | | | | | |
| | Hypro 2800x95 | | | | | 25.94 | | |
| | Hypro 1200x90 | 75.37 | | | | | 13.06 | |
| | Poly bd R20LM | | | | | | | 13.52 |
| Isocyanate | Isonate 50OP | 24.62 | 9.08 | 11.60 | 12.00 | 9.08 | 10.66 | 10.61 |
| source | | | | | | | | |
| Catalyst | DBTDL | 0.015 | 0.015 | 0.015 | 0.015 | 0.015 | 0.015 | 0.015 |

Rounded composition data in each case in percent by weight. The parts by weight of the individual components add up to 100. The indicated amounts of the hydroxyl-terminated polybutadienes and isocyanate source are mixed according to the general reaction procedure. To the obtained compositions, a capping solution that can comprise 6-7 parts by weight (based on 100 parts by weight of the above compositions) methacrylates (for example HPMA), the indicated amount of capping agent (DBTDL) and 1-3 parts by weight (based on 100 parts by weight of the above compositions) of photoinitiator (for example BIBE) may be added.

TABLE 4
Photopolymer compositions 47-61.

| | Number | 47 | 48 | 49 | 50 | 51 | 52 | 53 | 54 |
|---|---|---|---|---|---|---|---|---|---|
| hydroxyl-terminated | Nisso GI-3000 | 91.18 | | | | | | | |
| polybutadiene | Nisso GI-2000 | | 87.33 | | | | | | |
| | Nisso GI-1000 | | | 82.68 | | | | | |
| | Nisso G-3000 | | | | | | | | |
| | Nisso G-2000 | | | | | | | | |
| | Nisso G-1000 | | | | 81.60 | | | | |
| | Krasol LBH 2000 | | | | | 86.12 | | | |
| | Krasol LBH 3000 | | | | | | 89.73 | | |
| | Krasol LBHP 3000 | | | | | | | 90.30 | |
| | Poly bd R45HTLO | | | | | | | | |
| | Poly bd R45V | | | | | | | | 86.12 |
| | Hypro 2800x95 | | | | | | | | |
| | Hypro 1200x90 | | | | | | | | |
| | Poly bd R20LM | | | | | | | | |
| Isocyanate | ISONATE 143L | 8.81 | 12.65 | 17.30 | 18.39 | 13.86 | 10.26 | 9.68 | 13.86 |
| source | | | | | | | | | |
| Catalyst | DBTDL | 0.015 | 0.015 | 0.015 | 0.015 | 0.015 | 0.015 | 0.015 | 0.015 |

| | Number | 55 | 56 | 57 | 58 | 59 | 60 | 61 |
|---|---|---|---|---|---|---|---|---|
| hydroxyl-terminated | Nisso GI-3000 | | 64.05 | | | | 75.05 | 74.66 |
| polybutadiene | Nisso GI-2000 | | | | | | | |
| | Nisso GI-1000 | | | | 38.91 | | | |
| | Nisso G-3000 | | | | | 64.09 | | |
| | Nisso G-2000 | | | 54.33 | | | | |
| | Nisso G-1000 | | | | | | | |
| | Krasol LBH 2000 | | 25.62 | | | | | |
| | Krasol LBH 3000 | | | | 47.50 | | | |
| | Krasol LBHP 3000 | | | | | | | |
| | Poly bd R45HTLO | | | 32.53 | | | | |
| | Poly bd R45V | | | | | | | |
| | Hypro 2800x95 | | | | | 25.58 | | |
| | Hypro 1200x90 | 72.66 | | | | | 12.85 | |
| | Poly bd R20LM | | | | | | | 13.31 |
| Isocyanate | ISONATE 143L | 27.33 | 10.31 | 13.12 | 13.57 | 10.32 | 12.08 | 12.02 |
| source | | | | | | | | |
| Catalyst | DBTDL | 0.015 | 0.015 | 0.015 | 0.015 | 0.015 | 0.015 | 0.015 |

Rounded composition data in each case in percent by weight. The parts by weight of the individual components add up to 100. The indicated amounts of the hydroxyl-terminated polybutadienes and isocyanate source are mixed according to the general reaction procedure. To the obtained compositions, a capping solution that can comprise 6-7 parts by weight (based on 100 parts by weight of the above compositions) methacrylates (for example HPMA), the indicated amount of capping agent (DBTDL) and 1-3 parts by weight (based on 100 parts by weight of the above compositions) of photoinitiator (for example BIBE) may be added.

TABLE 5
Photopolymer compositions 62-76.

| | Number | 62 | 63 | 64 | 65 | 66 | 67 | 68 | 69 |
|---|---|---|---|---|---|---|---|---|---|
| hydroxyl-terminated | Nisso GI-3000 | 86.91 | | | | | | | |
| polybutadiene | Nisso GI-2000 | | 81.58 | | | | | | |
| | Nisso GI-1000 | | | 75.41 | | | | | |
| | Nisso G-3000 | | | | | | | | |
| | Nisso G-2000 | | | | | | | | |
| | Nisso G-1000 | | | | 74.01 | | | | |
| | Krasol LBH 2000 | | | | | 79.95 | | | |
| | Krasol LBH 3000 | | | | | | 84.88 | | |
| | Krasol LBHP 3000 | | | | | | | 85.68 | |
| | Poly bd R45HTLO | | | | | | | | |
| | Poly bd R45V | | | | | | | | 79.95 |
| | Hypro 2800x95 | | | | | | | | |
| | Hypro 1200x90 | | | | | | | | |
| | Poly bd R20LM | | | | | | | | |
| Isocyanate | ISONATE 240 | 13.07 | 18.41 | 24.57 | 25.97 | 20.04 | 15.11 | 14.30 | 20.04 |
| source | | | | | | | | | |
| Catalyst | DBTDL | 0.015 | 0.015 | 0.015 | 0.015 | 0.015 | 0.015 | 0.015 | 0.015 |

| | Number | 70 | 71 | 72 | 73 | 74 | 75 | 76 |
|---|---|---|---|---|---|---|---|---|
| hydroxyl-terminated | Nisso GI-3000 | | 60.57 | | | | 70.32 | 69.97 |
| polybutadiene | Nisso GI-2000 | | | | | | | |
| | Nisso GI-1000 | | | | 36.18 | | | |
| | Nisso G-3000 | | | | | 60.60 | | |
| | Nisso G-2000 | | | 50.63 | | | | |
| | Nisso G-1000 | | | | | | | |
| | Krasol LBH 2000 | | 24.23 | | | | | |
| | Krasol LBH 3000 | | | | 44.16 | | | |
| | Krasol LBHP 3000 | | | | | | | |
| | Poly bd R45HTLO | | | 30.32 | | | | |
| | Poly bd R45V | | | | | | | |
| | Hypro 2800x95 | | | | | 24.19 | | |
| | Hypro 1200x90 | 63.06 | | | | | 12.04 | |
| | Poly bd R20LM | | | | | | | 12.47 |
| Isocyanate | ISONATE 240 | 36.93 | 15.18 | 19.04 | 19.65 | 15.19 | 17.63 | 17.54 |
| source | | | | | | | | |
| Catalyst | DBTDL | 0.015 | 0.015 | 0.015 | 0.015 | 0.015 | 0.015 | 0.015 |

Rounded composition data in each case in percent by weight. The parts by weight of the individual components add up to 100. The indicated amounts of the hydroxyl-terminated polybutadienes and isocyanate source are mixed according to the general reaction procedure. To the obtained compositions, a capping solution that can comprise 6-7 parts by weight (based on 100 parts by weight of the above compositions) methacrylates (for example HPMA), the indicated amount of capping agent (DBTDL) and 1-3 parts by weight (based on 100 parts by weight of the above compositions) of photoinitiator (for example BIBE) may be added.

TABLE 6-1
Photopolymer compositions 77-88.

| | Number | 77 | 78 | 79 | 80 | 81 | 82 | 83 | 84 | 85 | 86 | 87 | 88 |
|---|---|---|---|---|---|---|---|---|---|---|---|---|---|
| hydroxyl- | Nisso GI-3000 | 88.63 | | | | | | 73.86 | | | | | |
| terminated | Nisso GI-2000 | | 86.25 | | | | | | 71.88 | | | | |
| poly- | Nisso GI-1000 | | | 83.28 | | | | | | 69.40 | | | |
| butadiene | Nisso G-1000 | | | | 82.57 | | | | | | 68.81 | | |
| | Krasol | | | | | 88.09 | | | | | | 73.41 | |
| | LBHP 3000 | | | | | | | | | | | | |
| | Hypro 1200x90 | | | | | | 76.46 | | | | | | 63.71 |
| Isocyanate | Mondur TD 80 | 5.16 | 7.53 | 10.51 | 11.22 | 5.69 | 17.33 | 4.30 | 6.28 | 8.76 | 9.35 | 4.74 | 14.44 |
| source | | | | | | | | | | | | | |
| Catalyst | DBTDL | 0.014 | 0.014 | 0.014 | 0.014 | 0.014 | 0.014 | 0.012 | 0.012 | 0.012 | 0.012 | 0.012 | 0.012 |
| (Meth)acrylate | HPMA | 6.10 | 6.10 | 6.10 | 6.10 | 6.10 | 6.10 | 5.08 | 5.08 | 5.08 | 5.08 | 5.08 | 5.08 |
| in capping | | | | | | | | | | | | | |
| solution | | | | | | | | | | | | | |
| (Meth)acrylate | LMA | | | | | | | 16.67 | 16.67 | 16.67 | 16.67 | 16.67 | 16.67 |
| as reactive | | | | | | | | | | | | | |
| diluent | | | | | | | | | | | | | |
| Antioxidant | BHT | 0.10 | 0.10 | 0.10 | 0.10 | 0.10 | 0.10 | 0.08 | 0.08 | 0.08 | 0.08 | 0.08 | 0.08 |

Rounded composition data in each case in percent by weight. The parts by weight of the individual components add up to 100. To the above compositions, another 1-3 parts by weight (based on 100 parts by weight of the above compositions) of photoinitiator (BIBE) may be added.

TABLE 6-2
Composition of photopolymer compositions 89-100.

| | Number | 89 | 90 | 91 | 92 | 93 | 94 | 95 | 96 | 97 | 98 | 99 | 100 |
|---|---|---|---|---|---|---|---|---|---|---|---|---|---|
| hydroxyl- | Nisso GI-3000 | 73.86 | | | | | | 73.86 | | | | | |
| terminated | Nisso GI-2000 | | 71.88 | | | | | | 71.88 | | | | |
| polybutadiene | Nisso GI-1000 | | | 69.40 | | | | | | 69.40 | | | |
| | Nisso G-1000 | | | | 68.81 | | | | | | 68.81 | | |
| | Krasol | | | | | 73.41 | | | | | | 73.41 | |
| | LBHP 3000 | | | | | | | | | | | | |
| | Hypro 1200x90 | | | | | | 63.71 | | | | | | 63.71 |
| Isocyanate | Mondur TD 80 | 4.30 | 6.28 | 8.76 | 9.35 | 4.74 | 14.44 | 4.30 | 6.28 | 8.76 | 9.35 | 4.74 | 14.44 |
| source | | | | | | | | | | | | | |
| Catalyst | DBTDL | 0.012 | 0.012 | 0.012 | 0.012 | 0.012 | 0.012 | 0.012 | 0.012 | 0.012 | 0.012 | 0.012 | 0.012 |
| (Meth)acrylate | HPMA | 5.08 | 5.08 | 5.08 | 5.08 | 5.08 | 5.08 | 5.08 | 5.08 | 5.08 | 5.08 | 5.08 | 5.08 |
| in capping | | | | | | | | | | | | | |
| solution | | | | | | | | | | | | | |
| (Meth)acrylate | EHA | 16.67 | 16.67 | 16.67 | 16.67 | 16.67 | 16.67 | 15.00 | 15.00 | 15.00 | 15.00 | 15.00 | 15.00 |
| as reactive | AA | | | | | | | 1.67 | 1.67 | 1.67 | 1.67 | 1.67 | 1.67 |
| diluent | | | | | | | | | | | | | |
| Antioxidant | BHT | 0.08 | 0.08 | 0.08 | 0.08 | 0.08 | 0.08 | 0.08 | 0.08 | 0.08 | 0.08 | 0.08 | 0.08 |

Rounded composition data in each case in percent by weight. The parts by weight of the individual components add up to 100. To the above compositions, another 1-3 parts by weight (based on 100 parts by weight of the above compositions) of photoinitiator (BIBE) may be added.

### Example B: Evaluation of Printing Quality

In this example, the print quality and dot gain of a cliché tape of the present invention and of a self-adhesive printing sleeve known from the prior art are compared. Cliché tapes according to the present invention were mounted on a hard-coat sleeve and compared with a MEDIUM Polymount Self-Adhesive Sleeve (TEST 1). For this test, cliché tapes comprising a layer of a photopolymer compound obtained by polymerizing the above photopolymer compositions 2, 10, 14, 17, 20, 24, 36, 47, 51, 62, 71, 77, 80, 83, 86, 89, 91, 92, 95, 97 and 99 (TEST 2a, TEST 2b . . . TEST 2u) were used.

| | | | MEDIUM Polymount | |
|---|---|---|---|---|
| | Present invention | | Self-Adhesive Sleeve | |
| Sample | TEST 2a, 2b . . . 2u | | TEST 1 | |
| Thickness of PET film | 36 | μm | 120 | μm |
| Thickness of photopoly- | 150 | μm | 400 | μm |
| mer layer | | | | |
| Thickness of PU | 310 | μm | 1500 | μm |
| carrier foam | | | | |

In addition, the cliché tape according to the present invention was compared to further classic, foam-supported adhesive tapes from the companies Lohmann, Tesa, 3M, and Orafol (TEST 3-TEST 6).

| | Orafol | | | | | | | |
|---|---|---|---|---|---|---|---|---|
| | Oraflex | | | | | | Lohmann Du- | |
| | 11555 | | 3M E1015H | | Tesa 52015 | | ploflex 4.2 | |
| Sample | TEST 3 | | TEST 4 | | TEST 5 | | TEST 6 | |
| Thickness of | 380 | μm | 380 | μm | 370 | μm | 380 | μm |
| foam layer + | | | | | | | | |
| reinforcement | | | | | | | | |
| layer | | | | | | | | |
| Tape thick- | 420 | μm | 420 | μm | 420 | μm | 420 | μm |

| | | | | |
|---|---|---|---|---|
| ness | | | | |
| hardness | medium | medium | medium | medium |

In order to test if the cliché tape of the present invention is compatible with the currently required print quality (level of technique) a so called finger-print test was performed. A fingerprint design allows to check print density and the quality of the minimum printing-dots. The test was performed with a Finger Print Plate (I) and a Cyan Print desk (II) at a Nilpeter FA4 printing machine.

### Example B-1

The plate (I) is mounted on top of the Polymount sleeve.
The combination is placed into the printing machine (II).
The printing pressure is set at a value commonly used for this application and run at 100 meter per minute printing speed.
The sample TEST 1 is taken.

### Examples B-2-a to B-2-u

The same plate (I) as in TEST 1 is on mounted on top of the hard-coat sleeve provided with the cliché tape of the present invention.
The combination is placed into the printing machine (II).
The printing pressure is set at a value commonly used for this application and run at 100 meter per minute printing speed.
The samples TEST 2a, TEST 2b, TEST 2c . . . TEST 2u are taken.

### Examples B-3 to B-6

The same plate (I) as in TEST 1 is on mounted on top of the hard-coat sleeve provided with the classic, foam-supported adhesive tapes available on the market.
The combination is placed into the printing machine (II).
The printing pressure is set at a value commonly used for this application and run at 100 meter per minute printing speed.
The samples TEST 3 to TEST 6 are taken.

### Evaluation

Optical evaluation: The printing quality was evaluated optically. All samples TEST 1, TEST 2a-TEST 2u and TEST 3-TEST 6 showed the same high printing quality.

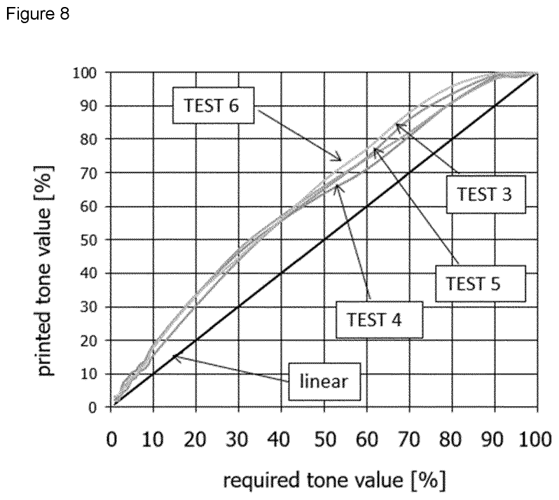

Dot gain curve: The printed tone value was measured with a microscope and density meters and compared with the required tone value. The results are shown in the graphs of FIGS. 6, 7 and 8. The dot gain curves for TEST 2a-TEST 2u were comparable and thus, only one exemplarily curve is shown in FIG. 7. The dot gain is comparable for all samples TEST 1, TEST 2a-TEST 2u and TEST 3-TEST 6.

Adhesive strength: No differences in adhesive strength of the photopolymer layer for attaching the fingerprint plate (I) in Example B-1, Examples B-2-a-B-2-u and Examples B-3 to B-6 was observed.

Despite the remarkably reduced thicknesses of the PU carrier foam in the cliché tape of the present invention in comparison to the Polymount system, the print quality and dot gain are comparable for all products. Reduction of the thickness of the photopolymer layer did not decrease the adhesive strength for attaching the fingerprint plate. The cliché tape of the present invention is a reusable product, which can be reused more frequently than standard cliché tapes. The decreased layer thicknesses of the cliché tape of the present invention in comparison to the layer thicknesses known from the prior art additionally increases sustainability of the inventive cliché tape. It provides a high printing quality comparable to that of the self-adhesive sleeves and classic, foam-supported adhesive tapes available on the market.

1.-16. (canceled)

17. A double-sided reusable cliché tape for removably attaching a flexographic printing cliché on a printing cylinder or printing sleeve, comprising:
(i) an adhesive layer on a cylinder side of the cliché tape;
(ii) a foam layer comprising a polyethylene (PE) or polyurethane (PU) foam;
(iii) a reinforcing layer comprising a polyester film; and
(iv) a layer of a photopolymer compound on a cliché side of the cliché tape,
wherein the photopolymer compound is used as a pressure-sensitive adhesive for attaching the printing cliché on the cliché tape using adherent and sticky characteristics of the photopolymer compound, and
wherein the foam layer has a thickness in the range of 150-500 μm.

18. The double-sided reusable cliché tape of claim 17, wherein the foam layer and the reinforcing layer are arranged such that the foam layer is closer to the cylinder side and the reinforcing layer is closer to the cliché side.

19. The double-sided reusable cliché tape of claim 17, wherein the foam layer comprises the PU foam.

20. The double-sided reusable cliché tape of claim 17, wherein the layer of the photopolymer compound has a thickness in the range of 100-350 μm.

21. The double-sided reusable cliché tape of claim 17, wherein the reinforcing layer has a thickness in the range of 19-100 μm.

22. The double-sided reusable cliché tape of claim 17, wherein the foam layer has a thickness in the range of 250-370 μm.

23. The double-sided reusable cliché tape of claim 17, wherein the cliché tape further comprises an additional adhesive layer arranged between the foam layer and the reinforcing layer.

24. The double-sided reusable cliché tape of claim 23, wherein the adhesive layer and/or the additional adhesive layer has a thickness in the range of 15-35 μm.

25. The double-sided reusable cliché tape of claim 23, wherein the adhesive layer and/or the additional adhesive layer comprises a pressure-sensitive adhesive.

26. The double-sided reusable cliché tape of claim 17, wherein the cliché tape further comprises a layer of a polyolefin film between the adhesive layer on the cylinder side and the foam layer.

27. The double-sided reusable cliché tape of claim 17, wherein the cliché tape further comprises a cover layer arranged on top of the layer of a photopolymer compound on the cliché side.

28. The double-sided reusable cliché tape of claim 17, wherein the reinforcing layer comprises a polyethylene terephthalate (PET) film.

29. The double-sided reusable cliché tape of claim 17, wherein the photopolymer compound is obtained by polymerizing a mixture comprising at least one hydroxyl-terminated polybutadiene and at least one isocyanate source.

30. The double-sided reusable cliché tape of claim 29, wherein the mixture further comprises at least one mono-, di-, tri- or polyfunctional (meth)acrylate.

31. A method for producing printed matter by flexographic printing comprising:
attaching the adhesive layer of the cliché tape of claim 17 on a printing cylinder or printing sleeve;
attaching a flexographic printing cliché on the layer of a photopolymer compound of the cliché tape; and
producing printed matter on a flexographic printing press.

32. The method of claim 31, further comprising removing the flexographic printing cliché from the layer of a photopolymer compound of the cliché tape.

33. The method of claim 32, further comprising removing the cliché tape from the printing cylinder or printing sleeve.

34. A double-sided reusable cliché tape for removably attaching a flexographic printing cliché on a printing cylinder or printing sleeve, comprising:
(i) an adhesive layer on a cylinder side of the cliché tape;
(ii) a film layer; and
(iv) a layer of a photopolymer compound on a cliché side of the cliché tape,
wherein the photopolymer compound is used as a pressure-sensitive adhesive for attaching the printing cliché on the cliché tape using adherent and sticky characteristics of the photopolymer compound, and
wherein the film layer has a thickness in the range of 23-370 μm.

35. The double-sided reusable cliché tape of claim 34, wherein one or more of:
(i) the adhesive layer has a thickness in the range of 15-35 μm; and
(ii) the layer of a photopolymer compound has a thickness in the range of 100-350 μm.

36. The double-sided reusable cliché tape of claim 34, wherein one or more of:
(i) the cliché tape further comprises a cover layer arranged on top of the layer of a photopolymer compound on the cliché side;
(ii) the photopolymer compound is obtained by polymerizing a mixture comprising at least one hydroxyl-terminated polybutadiene and at least one isocyanate source; and
(iii) the adhesive layer comprises a pressure-sensitive adhesive.
